(19) United States
(12) Patent Application Publication
(10) Pub. No.: US 2026/0214063 A1
(43) Pub. Date: Jul. 23, 2026

(54) ACCESS POINT ROUTER AND METHOD FOR SYSTEM DELAY SCHEDULING

(71) Applicant: MEDIATEK INC., Hsinchu City (TW)

(72) Inventors: Hung-Jung Kang, Hsinchu City (TW); Po-Chi Chen, Hsinchu City (TW); Ying-You Lin, Hsinchu City (TW)

(73) Assignee: MEDIATEK INC., Hsinchu City (TW)

(21) Appl. No.: 19/405,442

(22) Filed: Dec. 2, 2025

Related U.S. Application Data
(60) Provisional application No. 63/747,867, filed on Jan. 21, 2025.

(51) Int. Cl. H04L 47/56; H04L 43/0852

(52) U.S. Cl. CPC H04L 47/56; H04L 43/0852

(57) ABSTRACT

A method for system delay scheduling performed by an access point (AP) router includes monitoring a traffic status of data packets, determining an average burst duration based on the traffic status, and comparing the average burst duration with a first time threshold and a second, smaller time threshold. A second mode is selected if the average burst duration exceeds the first time threshold, and a first mode is selected if it is less than the second time threshold. In the first mode, a transmitter transmits the data packets via a first number of physical layer protocol data units (PPDUs). In the second mode, the transmitter transmits the data packets via a second number of PPDUs after a delay time. The second number of PPDUs is smaller than the first number of PPDUs.

### CROSS REFERENCE TO RELATED APPLICATIONS

This application claims the benefit of U.S. Provisional Application No. 63/747,867, filed on January 21, 2025. The content of the application is incorporated herein by reference.

### BACKGROUND

With the advancement of wireless communication technologies, such as the Institute of Electrical and Electronics Engineers (IEEE) 802.11 standards, data transmission rates supported by access points (APs) and stations (STAs) have increased significantly. Modern Wi-Fi systems are designed to provide high throughput to support various applications.

However, in practical usage scenarios, a data arrival rate of an application often does not match a maximum service rate supported by a Wi-Fi link. For example, video streaming services or online gaming applications may generate data traffic at a rate significantly lower than the capacity of the Wi-Fi connection. When the AP router receives data packets from a network interface, the AP router generally transmits the data packets to the STA immediately after a channel access procedure. Under a Carrier Sense Multiple Access with Collision Avoidance (CSMA/CA) mechanism, the AP router performs a back-off procedure and transmits the data packets as soon as a wireless channel is idle.

Consequently, when the data arrival rate of the application is much lower than the Wi-Fi service rate, the AP router transmits a large number of short Physical Layer Protocol Data Units (PPDUs). Each transmission of the short PPDU involves overheads such as a physical layer preamble, a back-off time, and a Block Acknowledgment (BA) from the receiving STA. The frequent transmission of the short PPDUs results in low air interface utilization and increased power consumption for both the AP router and the STA, as the devices are required to frequently wake up and perform channel access procedures. Existing mechanisms, such as Transmit Opportunity (TXOP) truncation, may address contention overhead but do not effectively resolve the power inefficiency caused by the continuous transmission of fragmented small packets.

### SUMMARY

In one embodiment, a method for system delay scheduling performed by an access point (AP) router is disclosed. The method comprises monitoring a traffic status of a plurality of data packets associated with an application; determining an average burst duration of the plurality of data packets based on the traffic status; comparing the average burst duration with a first time threshold and a second time threshold, wherein the first time threshold is greater than the second time threshold; selecting a second mode in response to the average burst duration being greater than the first time threshold; and selecting a first mode in response to the average burst duration being less than the second time threshold. In the first mode, a transmitter of the AP router transmits the plurality of data packets via a first number of physical layer protocol data units (PPDUs). In the second mode, the transmitter transmits the plurality of data packets via a second number of PPDUs after a delay time, wherein the second number of PPDUs is smaller than the first number of PPDUs.

In another embodiment, an access point (AP) router is disclosed. The AP router comprises a transmitter, a transmission traffic monitor, and a delay transmission controller coupled to the transmission traffic monitor and the transmitter. The transmission traffic monitor is configured to monitor a traffic status of a plurality of data packets associated with an application. The delay transmission controller is configured to determine an average burst duration of the plurality of data packets based on the traffic status, compare the average burst duration with a first time threshold and a second time threshold, select a second mode in response to the average burst duration being greater than the first time threshold, and select a first mode in response to the average burst duration being less than the second time threshold, wherein the first time threshold is greater than the second time threshold. In the first mode, the transmitter transmits the plurality of data packets via a first number of physical layer protocol data units (PPDUs). In the second mode, the transmitter transmits the plurality of data packets via a second number of PPDUs after a delay time, wherein the second number of PPDUs is smaller than the first number of PPDUs.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an access point (AP) router according to an embodiment of the present invention.

FIG. 2 is a timing diagram illustrating a downlink transmission sequence with system delay scheduling performed by the AP router in FIG. 1 according to an embodiment of the present invention.

FIG. 3 is a timing diagram illustrating an uplink transmission sequence with system delay scheduling performed by the AP router in FIG. 1 according to an embodiment of the present invention.

FIG. 4 is a timing diagram illustrating definitions of time parameters used in system delay scheduling according to an embodiment of the present invention.

FIG. 5 is a flowchart of a detailed process for mode selection and delay time determination performed by the AP router in FIG. 1 according to an embodiment of the present invention.

FIG. 6 is a flowchart of a method for system delay scheduling performed by the AP router in FIG. 1 according to an embodiment of the present invention.

### DETAILED DESCRIPTION

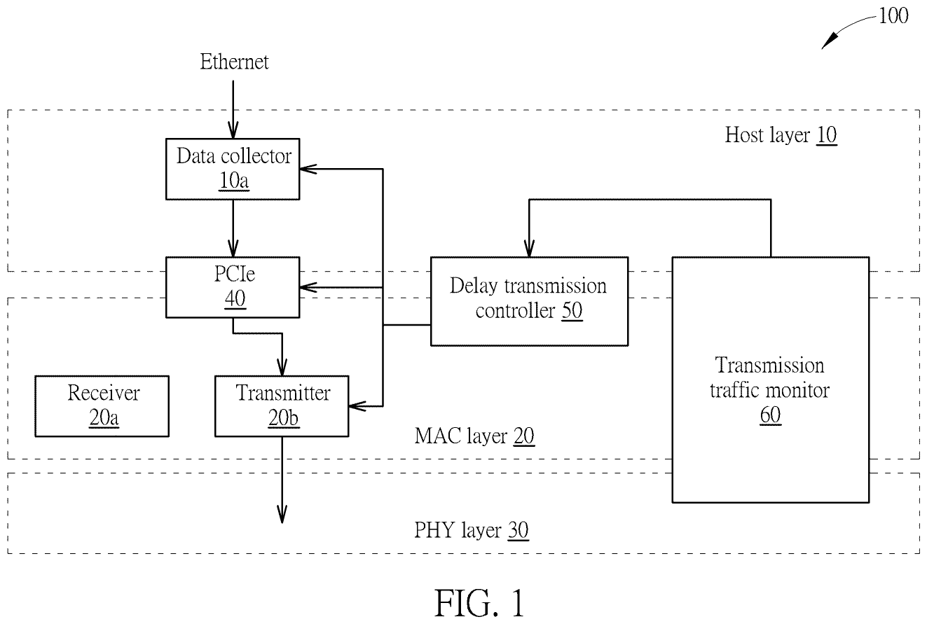

FIG. 1 is a schematic diagram of an access point (AP) router 100 according to an embodiment of the present invention. The AP router 100 is designed to perform system delay scheduling to optimize power consumption and air interface utilization by effectively managing data transmission based on traffic characteristics.

In terms of hardware architecture, the AP router 100 includes a processor (not shown) and a memory (not shown) coupled to the processor. The processor can be a Central Processing Unit (CPU), a Microcontroller Unit (MCU), an Application Specific Integrated Circuit (ASIC), or a Field Programmable Gate Array (FPGA). The memory can include volatile memory (e.g., Random Access Memory (RAM)) and non-volatile memory (e.g., Flash memory or Read-Only Memory (ROM)). The memory stores instructions or software modules that, when executed by the processor, cause the AP router 100 to perform the functions and methods described herein. Specifically, functional blocks such as a delay transmission controller 50 and a transmission traffic monitor 60, which will be described in detail below, can be implemented as software codes executed by the processor, dedicated hardware logic circuits, or a combination thereof. This hardware-software cooperation ensures that the logical operations of traffic monitoring and mode selection are physically realized within the AP router 100.

As illustrated in FIG. 1, the AP router 100 hierarchically includes a host layer 10, a media access control (MAC) layer 20, and a physical (PHY) layer 30. The AP router 100 further includes a Peripheral Component Interconnect Express (PCIe) interface 40 coupled between the host layer 10 and the MAC layer 20, serving as a high-speed data bus for data transfer.

The host layer 10 includes a data collector 10a. The data collector 10a is configured to receive a plurality of data packets associated with an application from an external network connection, such as an Ethernet interface. The data collector 10a can be regarded as a data buffer or a packet queue located in a driver of the host layer 10. The data collector 10a holds the incoming data packets before transferring the data packets to the MAC layer 20 via the PCIe interface 40.

The MAC layer 20 includes a receiver 20a and a transmitter 20b. The receiver 20a is configured to process uplink signals received from the PHY layer 30. The transmitter 20b is configured to process downlink data and configured to transmit the plurality of data packets via the PHY layer 30 in the form of physical layer protocol data units (PPDUs).

The AP router 100 includes the transmission traffic monitor 60 and the delay transmission controller 50. In the embodiment shown in FIG. 1, the transmission traffic monitor 60 is coupled to the transmitter 20b via the delay transmission controller 50. The delay transmission controller 50 is further coupled to the transmitter 20b. It should be noted that while FIG. 1 illustrates specific coupling relations, the delay transmission controller 50 is also operatively coupled to the data collector 10a and the PCIe interface 40 to assert control signals for delay scheduling.

The transmission traffic monitor 60 is configured to monitor a traffic status of the plurality of data packets associated with the application. Specifically, the transmission traffic monitor 60 observes parameters such as a packet arrival time, a packet size, a burst size, and a burst period of the incoming data traffic. In addition to the application traffic, the transmission traffic monitor 60 is further configured to monitor wireless channel parameters, including a physical layer (PHY) transmission rate and a back-off time. These parameters assist the delay transmission controller 50 in estimating the PPDU duration and the system latency with greater accuracy. The monitoring can be performed at the host layer 10 (e.g., monitoring Ethernet packets) or at the MAC layer 20. The transmission traffic monitor 60 provides the monitored traffic status to the delay transmission controller 50.

The delay transmission controller 50 operates as a decision-making unit for the system delay scheduling. The delay transmission controller 50 is configured to determine an average burst duration (ABD) of the plurality of data packets based on the traffic status provided by the transmission traffic monitor 60. To determine an appropriate operation mode, the delay transmission controller 50 compares the average burst duration with a first time threshold and a second time threshold. In this embodiment, the first time threshold is greater than the second time threshold. Based on the comparison result, the delay transmission controller 50 selects one of a first mode and a second mode. Specifically, the delay transmission controller 50 selects the second mode in response to the average burst duration being greater than the first time threshold, and selects the first mode in response to the average burst duration being less than the second time threshold.

In the first mode, the delay transmission controller 50 does not impose an additional delay for aggregation purposes. Consequently, the transmitter 20b transmits the plurality of data packets via a first number of PPDUs. This corresponds to a conventional transmission behavior where data is transmitted essentially as it arrives or after a standard back-off procedure.

In the second mode, the delay transmission controller 50 determines a delay time and controls the AP router 100 to delay the transmission of the plurality of data packets by the delay time. This intentional delay enables the AP router 100 to accumulate the plurality of data packets. After the delay time expires, the transmitter 20b transmits the accumulated plurality of data packets via a second number of PPDUs. A feature of the present invention is that the second number of PPDUs is smaller than the first number of PPDUs, indicating that the data packets have been aggregated into fewer, larger PPDUs (e.g., Aggregated MPDUs) to reduce transmission overhead.

Furthermore, the delay transmission controller 50 can perform the delay of the transmission to accumulate the data packets at various locations within the AP router 100. In one embodiment, the delay transmission controller 50 controls the data collector 10a in the host layer 10 to buffer the data packets. In another embodiment, the delay transmission controller 50 controls the PCIe interface 40 to delay the transfer of data packets. In yet another embodiment, the delay transmission controller 50 controls the transmitter 20b in the MAC layer 20 to schedule the transmission after the delay time. This flexible architecture enables the delay scheduling to be optimized based on specific hardware capabilities and system requirements.

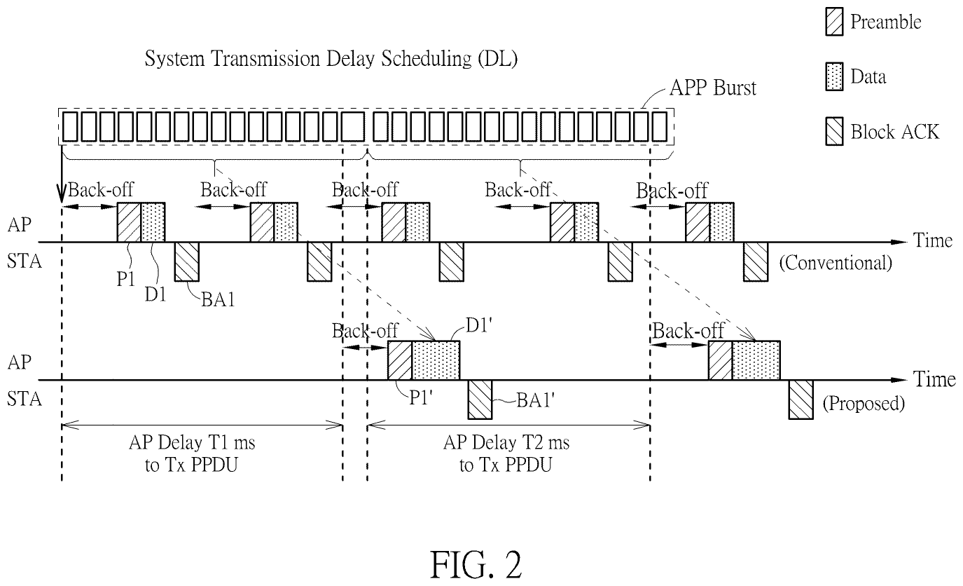

FIG. 2 is a timing diagram illustrating a downlink transmission sequence with system delay scheduling performed by the AP router 100 in FIG. 1 according to an embodiment of the present invention. The timing diagram contrasts a transmission behavior in the first mode (labeled as “Conventional”) with a transmission behavior in the second mode (labeled as “Proposed”) in response to an identical application (APP) burst.

The upper portion of FIG. 2 depicts the APP burst, which consists of a plurality of data packets arriving sequentially from an application layer over a period of time. This scenario corresponds to a case where a service rate of the Wi-Fi link is significantly higher than a data arrival rate of the application, such as in video streaming or online gaming scenarios.

The middle portion of FIG. 2 illustrates the operation in the first mode. When the AP router 100 operates in the first mode, the AP router 100 initiates a transmission procedure immediately upon receiving the data packets or after a standard channel access delay (e.g., a random back-off). As a result, the transmitter 20b transmits a PPDU comprising a preamble P1 and a data payload D1. Since the transmission occurs frequently without intentional delay, the data payload D1 contains only a small amount of data (e.g., a single packet or a few packets). The station (STA) receives the PPDU and replies with a Block Acknowledgment (BA1). This process repeats for each subsequent arrival of data packets within the APP burst. Consequently, the transmitter 20b transmits the plurality of data packets via a first number of PPDUs (multiple short PPDUs in this example). This behavior results in significant overhead due to the repeated preambles P1, back-off periods, and Block Acknowledgments BA1.

The lower portion of FIG. 2 illustrates the operation in the second mode, which implements the system delay scheduling of the present invention. When the delay transmission controller 50 selects the second mode, the delay transmission controller 50 determines a delay time, indicated as AP Delay T1 and AP Delay T2 in FIG. 2. The AP router 100 delays the transmission of the incoming data packets for the duration of the delay time. During the AP Delay T1, the AP router 100 accumulates the arriving data packets in the host layer 10, the PCIe interface 40, or the MAC layer 20. In FIG. 2, multiple data packets from the APP burst are grouped together during the AP Delay T1.

After the AP Delay T1 expires, the transmitter 20b performs a back-off procedure and transmits the accumulated plurality of data packets in a single aggregated PPDU. In FIG. 2, the aggregated PPDU includes a preamble P1′ and a data payload D1'. The data payload D1′ has a longer duration than the data payload D1 because it aggregates a larger amount of data collected during the delay time. The STA receives this longer PPDU and replies with a single Block Acknowledgment (BA1′). Similarly, for the subsequent portion of the APP burst, the AP router 100 waits for the AP Delay T2, accumulates more data, and transmits another aggregated PPDU.

In the second mode, the transmitter 20b transmits the plurality of data packets via a second number of PPDUs. As visually demonstrated in FIG. 2, the second number of PPDUs (two long PPDUs in this example) is smaller than the first number of PPDUs (multiple short PPDUs) transmitted in the first mode. This reduction in the number of transmissions significantly decreases the overhead associated with channel contention, physical layer headers, and control frames, thereby improving air interface efficiency and reducing power consumption for both the AP router 100 and the STA.

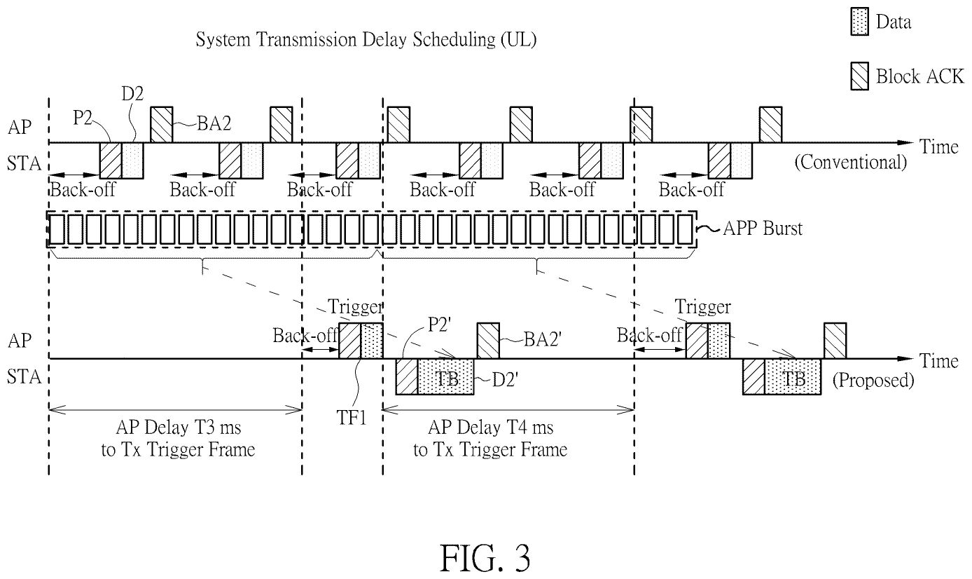

FIG. 3 is a timing diagram illustrating an uplink transmission sequence with system delay scheduling performed by the AP router 100 in FIG. 1 according to an embodiment of the present invention. The timing diagram contrasts a transmission behavior in the first mode (labeled as “Conventional”) with a transmission behavior in the second mode (labeled as “Proposed”) regarding the uplink traffic generated by the station (STA).

The middle portion of FIG. 3 depicts the APP burst occurring at the STA side. Similar to the downlink scenario, the APP burst consists of a plurality of data packets arriving sequentially from an application layer of the STA over a period of time.

The upper portion of FIG. 3 illustrates the operation in the first mode. In this mode, the STA operates under a conventional mechanism, such as the Carrier Sense Multiple Access with Collision Avoidance (CSMA/CA). When data packets arrive, the STA performs a back-off procedure and transmits the data packets as soon as the channel is idle. Consequently, the STA transmits a PPDU comprising a preamble P2 and a data payload D2 containing a small amount of data. The AP router 100 receives the PPDU and replies with a Block Acknowledgment (BA2). Because the STA attempts to transmit immediately upon data arrival, this process repeats frequently, resulting in the transmission of a first number of PPDUs (multiple short PPDUs). This frequent contention and transmission lead to high power consumption for the STA and inefficient air interface usage due to the repeated overheads.

The lower portion of FIG. 3 illustrates the operation in the second mode, where the AP router 100 applies the system delay scheduling to the uplink transmission. In this embodiment, the delay transmission controller 50 performs an uplink delay control. Based on the monitored traffic status (e.g., inferred from previous traffic patterns or buffer status reports), the delay transmission controller 50 determines a delay time, indicated as AP Delay T3 and AP Delay T4 in FIG. 3.

Unlike the downlink scenario, where the data is buffered in the AP router 100, in the uplink scenario, the AP router 100 controls the timing of the transmission by delaying a transmission of a trigger frame TF1 to the STA. The trigger frame TF1 is a control frame used to allocate resources and solicit an uplink transmission from the STA (e.g., in High Efficiency (HE) or Extremely High Throughput (EHT) WLANs). During the AP Delay T3, the AP router 100 refrains from sending the trigger frame TF1. This intentional delay enables the STA to accumulate the arriving data packets in its buffer.

After the AP Delay T3 expires, the transmitter 20b transmits the trigger frame TF1 to the STA. Upon receiving the trigger frame TF1, the STA transmits a trigger-based (TB) PPDU in response. In FIG. 3, the TB PPDU comprises a preamble P2′ and an aggregated data payload D2′. The data payload D2′ aggregates the data packets accumulated during the delay time. The AP router 100 then replies with a single Block Acknowledgment (BA2′).

In the second mode, the uplink transmission is managed such that the STA transmits the plurality of data packets via a second number of PPDUs (e.g., TB PPDUs). As illustrated, the second number of PPDUs is smaller than the first number of PPDUs transmitted in the first mode. By consolidating multiple short uplink transmissions into fewer, larger TB PPDUs controlled by the trigger frame TF1, the system delay scheduling significantly reduces the number of channel access attempts and the associated overhead, thereby extending the battery life of the STA and improving overall network efficiency.

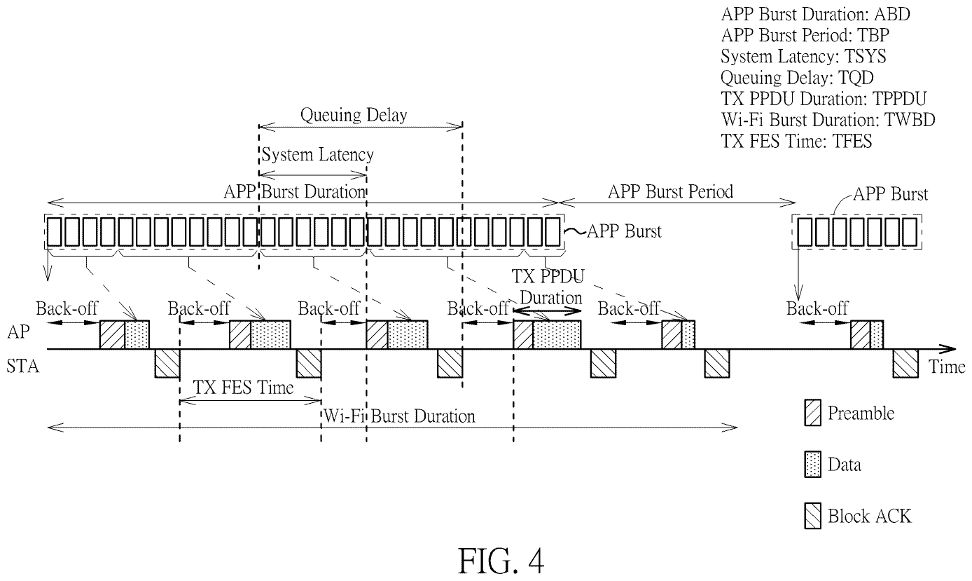

FIG. 4 is a timing diagram illustrating definitions of time parameters used in system delay scheduling according to an embodiment of the present invention. These time parameters are monitored or calculated by the transmission traffic monitor 60 and utilized by the delay transmission controller 50 to perform the mode selection and the delay time determination.

As shown in FIG. 4, an application (APP) burst comprises a series of data packets generated by an application. An average burst duration ABD represents a time duration from an arrival of a first data packet of the APP burst to an arrival of a last data packet of the APP burst. The delay transmission controller 50 uses the average burst duration ABD as a primary metric for determining whether to switch from the first mode to the second mode. An average burst period TBP represents a time interval between two consecutive APP bursts, specifically from a start of one APP burst to a start of a next APP burst.

FIG. 4 also illustrates the corresponding Wi-Fi transmission parameters. A transmission physical layer protocol data unit (PPDU) duration TPPDU represents a time duration required to transmit a single PPDU over the air interface. A transmission frame exchange sequence (FES) time TFES represents a total time required for a complete transmission sequence, which includes a back-off time, the transmission PPDU duration TPPDU, a Short Interframe Space (SIFS), and a duration of a Block Acknowledgment (BA). A Wi-Fi burst duration TWBD represents a total time required for the AP router 100 to complete the transmission of all data packets within the single APP burst.

Moreover, FIG. 4 defines latency metrics used for system evaluation. A system latency TSYS represents a time interval starting from an arrival of a data packet at the AP router 100 (e.g., at the data collector 10a) and ending at a start of a transmission of the data packet by the transmitter 20b (i.e., when the PPDU containing the data packet begins transmission). The delay transmission controller 50 compares the system latency TSYS with the determined delay time to ensure that the delay scheduling provides a valid gain. A queuing delay TQD represents a time interval starting from the arrival of the data packet and ending at a completion of the transmission, which is marked by a reception of the Block Acknowledgment from the station STA. It should be understood that the queuing delay TQD accounts for both the system wait time and the actual transmission overhead.

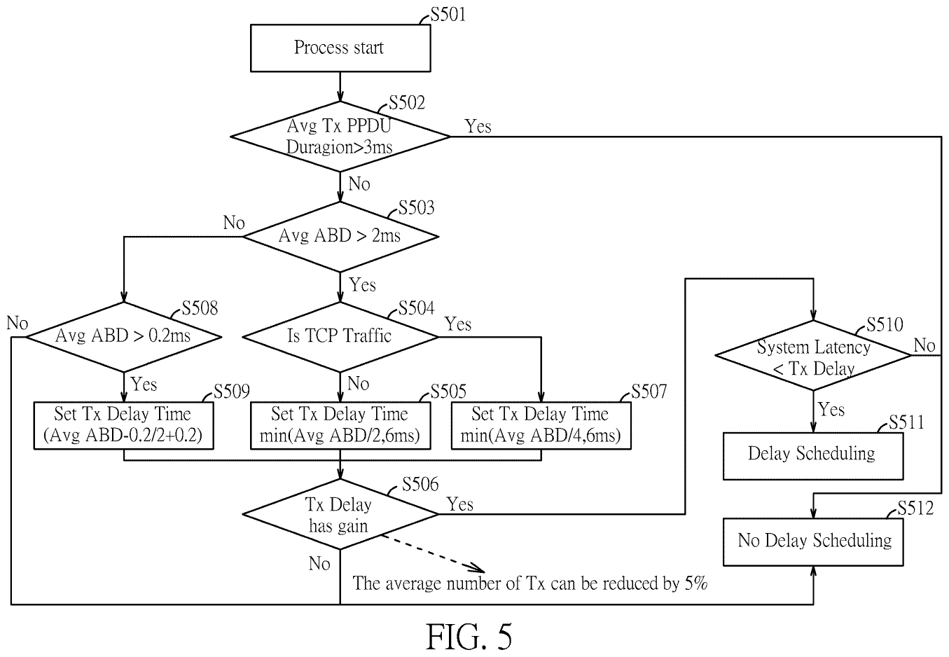

FIG. 5 is a flowchart of a detailed process for mode selection and delay time determination performed by the AP router 100 in FIG. 1 according to an embodiment of the present invention. The process illustrates the logic implemented by the delay transmission controller 50 to arbitrate between the first mode (No Delay Scheduling) and the second mode (Delay Scheduling) based on the traffic status provided by the transmission traffic monitor 60.

The process starts at step S501. At step S502, the delay transmission controller 50 determines whether a current transmission efficiency is high enough by comparing an average transmission PPDU duration (TPPDU) with a duration threshold. In this embodiment, the duration threshold is set to 3 milliseconds (ms). If the average transmission PPDU duration is greater than 3 ms, it indicates that the AP router 100 is already transmitting long PPDUs, and thus no further aggregation is required. In this case, the process proceeds to step S512, where the delay transmission controller 50 selects the first mode (No Delay Scheduling). Conversely, if the average transmission PPDU duration is less than or equal to 3 ms, the process proceeds to step S503 to evaluate the traffic burst characteristics.

At step S503, the delay transmission controller 50 determines whether the application traffic exhibits a long burst characteristic by comparing the average burst duration (ABD) with a first time threshold. In this embodiment, the first time threshold is set to 2 ms. If the average burst duration ABD is greater than 2 ms, the process proceeds to step S504.

Step S504 involves determining a traffic protocol type to optimize the delay time. The delay transmission controller 50 determines whether the plurality of data packets corresponds to a Transmission Control Protocol (TCP) traffic. Since TCP traffic is sensitive to latency due to its congestion control mechanism, a shorter delay time is preferred.

If the traffic is determined to be TCP traffic (Yes at step S504), the process proceeds to step S507. At step S507, the delay transmission controller 50 sets the delay time based on a minimum value between a first calculated value and a maximum delay limit. The first calculated value is derived from the average burst duration ABD divided by a first factor. In this embodiment, the first factor is 4, and the maximum delay limit is 6 ms. Accordingly, the delay time is calculated as min (ABD/4, 6 ms).

If the traffic is determined not to be TCP traffic (e.g., User Datagram Protocol (UDP) traffic) (No at step S504), the process proceeds to step S505. At step S505, the delay transmission controller 50 sets the delay time based on a minimum value between a second calculated value and the maximum delay limit. The second calculated value is derived from the average burst duration ABD divided by a second factor. In this embodiment, the second factor is 2. Accordingly, the delay time is calculated as min(ABD/2, 6 ms). Notably, the second factor (e.g., 2) is smaller than the first factor (e.g., 4), allowing for a longer delay time for non-TCP traffic to maximize aggregation efficiency.

Returning to step S503, if the average burst duration ABD is not greater than 2 ms, the process proceeds to step S508 to check for medium bursts. At step S508, the delay transmission controller 50 compares the average burst duration ABD with a second time threshold. In this embodiment, the second time threshold is set to 0.2 ms. If the average burst duration ABD is less than or equal to 0.2 ms, it indicates that the burst is too short to benefit from delay scheduling. Consequently, the process proceeds to step S512 (No Delay Scheduling).

If the average burst duration ABD is greater than 0.2 ms (i.e., between 0.2 ms and 2 ms), the process proceeds to step S509. At step S509, the delay transmission controller 50 sets the delay time based on a calculation formula. The formula involves a sum of a base time offset and a portion of a difference between the average burst duration ABD and the second time threshold. In this embodiment, the formula is expressed as (ABD−0.2)/2+0.2,where 0.2 ms represents both the second time threshold and the base time offset.

After the delay time is set in step S505, S507, or S509, the process proceeds to step S506. At step S506, the delay transmission controller 50 evaluates whether the determined delay time provides a sufficient gain. In one embodiment, this evaluation is based on whether an average number of transmissions can be reduced by a predetermined percentage, for example, 5%. If the estimated gain is insufficient (No at step S506), the process proceeds to step S512 to maintain the first mode.

If the gain is sufficient (Yes at step S506), the process proceeds to step S510. At step S510, the delay transmission controller 50 compares a system latency TSYS of the AP router 100 with the determined delay time (Tx Delay). This step ensures that the calculated delay time is meaningful compared to the inherent latency of the system. Specifically, if the inherent system latency TSYS is already greater than or equal to the determined delay time, imposing the determined delay time would not result in accumulating significantly more data packets than the system currently does naturally. In such a case (No at step S510), the delay scheduling is considered redundant, and the process proceeds to step S512. Conversely, if the system latency TSYS is less than the determined delay time (Yes at step S510), it implies that the determined delay time effectively extends an accumulation window beyond the inherent system aggregation capabilities. Consequently, the process proceeds to step S511.

At step S511, the delay transmission controller 50 selects the second mode (Delay Scheduling). In this mode, the AP router 100 delays the transmission by the determined delay time to accumulate data packets before transmission. At step S512, the delay transmission controller 50 selects the first mode (No Delay Scheduling), where data packets are transmitted without the additional delay time calculated in steps S505, S507, or S509.

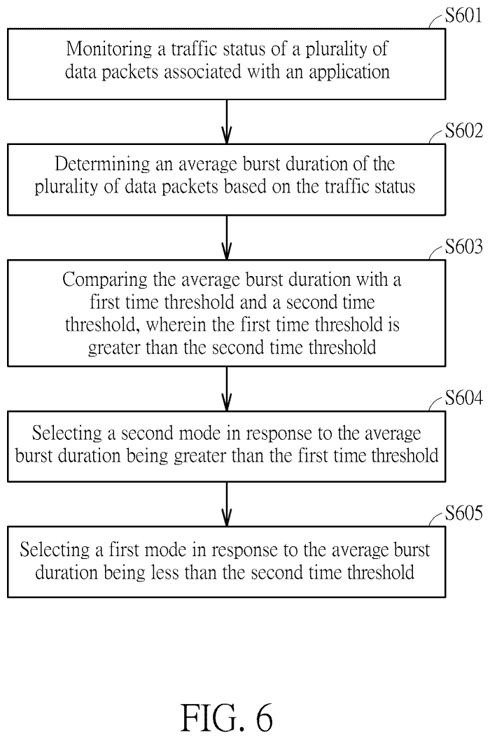

FIG. 6 is a flowchart of a method for system delay scheduling performed by the AP router 100 in FIG. 1 according to an embodiment of the present invention. The method includes step S601 to step S605. Any hardware or technology modification falls into the scope of the present invention. Step S601 to step S605 are illustrated below.
Step S601: monitoring a traffic status of a plurality of data packets associated with an application;
Step S602: determining an average burst duration of the plurality of data packets based on the traffic status;
Step S603: comparing the average burst duration with a first time threshold and a second time threshold, wherein the first time threshold is greater than the second time threshold;
Step S604: selecting a second mode in response to the average burst duration being greater than the first time threshold;
Step S605: selecting a first mode in response to the average burst duration being less than the second time threshold.

Details of step S601 to step S605 are previously illustrated. Thus, they are omitted here. By executing step S601 to step S605, the AP router 100 enables an adaptive transmission strategy based on the traffic status. For example, when the second mode is selected in response to the average burst duration being greater than the first time threshold, the system delay scheduling permits an accumulation of the plurality of data packets. Consequently, the transmitter 20b transmits the plurality of data packets via the second number of PPDUs, which is smaller than the first number of PPDUs associated with the first mode. This reduction in a transmission frequency effectively decreases control overheads, such as a back-off time and a Block Acknowledgment (BA), thereby optimizing air interface utilization and improving power efficiency of both the AP router 100 and the STA.

In summary, the embodiments of the present invention provide a method and an AP router for system delay scheduling. The AP router is configured to monitor a traffic status and determine an average burst duration. By comparing the average burst duration with specific thresholds, the AP router adaptively switches between a first mode and a second mode. In the second mode, the AP router introduces a delay time to accumulate data packets, thereby transmitting the data packets via a reduced number of aggregated PPDUs. This approach can minimize transmission overheads and enhances power efficiency for both the AP router and the STA.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for system delay scheduling performed by an access point (AP) router, the method comprising:
monitoring a traffic status of a plurality of data packets associated with an application;
determining an average burst duration of the plurality of data packets based on the traffic status;
comparing the average burst duration with a first time threshold and a second time threshold, wherein the first time threshold is greater than the second time threshold;
selecting a second mode in response to the average burst duration being greater than the first time threshold; and
selecting a first mode in response to the average burst duration being less than the second time threshold;
wherein in the first mode, a transmitter of the AP router transmits the plurality of data packets via a first number of physical layer protocol data units (PPDUs); and wherein in the second mode, the transmitter transmits the plurality of data packets via a second number of PPDUs after a delay time, wherein the second number of PPDUs is smaller than the first number of PPDUs.

2. The method of claim 1, further comprising:
monitoring an average PPDU duration of the transmitter;
comparing the average PPDU duration with a duration threshold; and
selecting the first mode in response to the average PPDU duration being greater than the duration threshold.

3. The method of claim 1, wherein the delay time is determined by:
determining whether the plurality of data packets corresponds to a Transmission Control Protocol (TCP) traffic; and
in response to the plurality of data packets corresponding to the TCP traffic, setting the delay time based on a minimum value between a first calculated value and a maximum delay limit, wherein the first calculated value is derived from the average burst duration divided by a first factor.

4. The method of claim 3, wherein the delay time in the second mode is further determined by:
in response to the plurality of data packets not corresponding to the TCP traffic, setting the delay time based on a minimum value between a second calculated value and the maximum delay limit, wherein the second calculated value is derived from the average burst duration divided by a second factor, and the second factor is smaller than the first factor.

5. The method of claim 1, further comprising:
selecting the second mode in response to the average burst duration being between the second time threshold and the first time threshold; and
setting the delay time based on a sum of a base time offset and a portion of a difference between the average burst duration and the second time threshold.

6. The method of claim 1, further comprising:
estimating a system latency of the AP router;
comparing the system latency with the delay time; and
switching from the second mode to the first mode in response to the system latency being greater than or equal to the delay time.

7. The method of claim 1, wherein the delay time is a controllable value distinct from a random back-off time, and the second number of PPDUs corresponds to at least one aggregated PPDU.

8. The method of claim 1, wherein the plurality of data packets are accumulated in a host layer, a Peripheral Component Interconnect Express (PCIe) interface, or a media access control (MAC) layer of the AP router during the delay time.

9. The method of claim 1, wherein the traffic status comprises a packet arrival time, a packet size, a burst size, and a burst period associated with the plurality of data packets.

10. The method of claim 1, wherein the transmitter of the AP router transmits the plurality of data packets to a station (STA) in a downlink transmission; or wherein the transmitter transmits a trigger frame to the STA to trigger an uplink transmission.

11. An access point (AP) router, comprising:
a transmitter;
a transmission traffic monitor; and
a delay transmission controller coupled to the transmission traffic monitor and the transmitter;
wherein the transmission traffic monitor is configured to monitor a traffic status of a plurality of data packets associated with an application; wherein the delay transmission controller is configured to determine an average burst duration of the plurality of data packets based on the traffic status, compare the average burst duration with a first time threshold and a second time threshold, select a second mode in response to the average burst duration being greater than the first time threshold, and select a first mode in response to the average burst duration being less than the second time threshold, wherein the first time threshold is greater than the second time threshold;
wherein in the first mode, the transmitter transmits the plurality of data packets via a first number of physical layer protocol data units (PPDUs); and wherein in the second mode, the transmitter transmits the plurality of data packets via a second number of PPDUs after a delay time, wherein the second number of PPDUs is smaller than the first number of PPDUs.

12. The AP router of claim 11, wherein the transmission traffic monitor is further configured to monitor an average PPDU duration of the transmitter; and the delay transmission controller selects the first mode in response to the average PPDU duration being greater than a duration threshold.

13. The AP router of claim 11, wherein the delay time is determined by the delay transmission controller determining whether the plurality of data packets corresponds to a Transmission Control Protocol (TCP) traffic; and wherein in response to the plurality of data packets corresponding to the TCP traffic, the delay transmission controller sets the delay time based on a minimum value between a first calculated value and a maximum delay limit, wherein the first calculated value is derived from the average burst duration divided by a first factor.

14. The AP router of claim 13, wherein in response to the plurality of data packets not corresponding to the TCP traffic, the delay transmission controller sets the delay time based on a minimum value between a second calculated value and the maximum delay limit, wherein the second calculated value is derived from the average burst duration divided by a second factor, and the second factor is smaller than the first factor.

15. The AP router of claim 11, wherein the delay transmission controller is further configured to select the second mode in response to the average burst duration being between the second time threshold and the first time threshold, and set the delay time based on a sum of a base time offset and a portion of a difference between the average burst duration and the second time threshold.

16. The AP router of claim 11, wherein the delay transmission controller is further configured to estimate a system latency of the AP router, compare the system latency with the delay time, and switch from the second mode to the first mode in response to the system latency being greater than or equal to the delay time.

17. The AP router of claim 11, wherein the delay time is a controllable value distinct from a random back-off time, and the second number of PPDUs corresponds to at least one aggregated PPDU.

18. The AP router of claim 11, further comprising: a host layer; a media access control (MAC) layer; and a Peripheral Component Interconnect Express (PCIe) interface coupled between the host layer and the MAC layer; wherein the plurality of data packets are accumulated in the host layer, the PCIe interface, or the MAC layer during the delay time.

19. The AP router of claim 11, wherein the traffic status comprises a packet arrival time, a packet size, a burst size, and a burst period associated with the plurality of data packets.

20. The AP router of claim 11, wherein the transmitter transmits the plurality of data packets to a station (STA) in a downlink transmission; or wherein the transmitter transmits a trigger frame to the STA to trigger an uplink transmission.
